(19) United States
(12) Patent Application Publication
(10) Pub. No.: US 2026/0006498 A1
(43) Pub. Date: Jan. 1, 2026

(54) TECHNIQUES TO INCREASE CAPACITY WITH MULTI-LINK OPERATION (MLO)

(71) Applicant: QUALCOMM Incorporated, San Diego, CA (US)

(72) Inventors: Shalabh PARMAR, San Jose, CA (US); Harsha VITTAL, Livermore, CA (US); Gyanranjan HAZARIKA, Milpitas, CA (US); Sandip HOMCHAUDHURI, San Jose, CA (US); Karthikeyan NAGARAJAN, Chennai (IN); Simon Jan BRAND, Pleasanton, CA (US)

(21) Appl. No.: 18/761,071

(22) Filed: Jul. 1, 2024

(51) Int. Cl. H04W 28/20; H04W 28/08; H04W 76/25

(52) U.S. Cl. CPC H04W 28/20; H04W 28/095; H04W 28/0983; H04W 76/25

(57) ABSTRACT

This disclosure provides methods, components, devices and systems for techniques to increase capacity with multi-link operation (MLO). Some aspects more specifically relate to modifying a usage of a multi-link connection based on observed traffic metrics associated with wireless devices. A first wireless device may observe a traffic metric that indicates an absence of traffic associated with one or more links of the multi-link connection or an underutilization of the one or more links of the multi-link connection over a time window. The first wireless device may request a reduction in a quantity of operating links of the multi-link connection between the first wireless device and a second wireless device in accordance with the observed traffic metric. The first wireless device may request reduction in a quantity of operating links, and may communicate with the second wireless device in accordance with the requested reduction in the quantity of operating links.

### TECHNICAL FIELD

This disclosure relates generally to wireless communication and, more specifically, to techniques to increase capacity with multi-link operation (MLO). The disclosure relates to adjusting a quantity of operating links to increase capacity of a wireless communication system.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide enhanced performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication at a first wireless device. The method may include transmitting, in accordance with an observed traffic metric between the first wireless device and a second wireless device, a message requesting a reduction in a quantity of operating links associated with a multi-link connection between the first wireless device and the second wireless device, where the message indicates at least one wireless device associated with a reduced quantity of operating links, and where the observed traffic metric indicates an absence of traffic associated with one or more links of the multi-link connection over a time window or an underutilization of the one or more links of the multi-link connection over the time window and communicating with the second wireless device in accordance with the requested reduction in the quantity of operating links.

Another innovative aspect of the subject matter described in this disclosure can be implemented in a first wireless device for wireless communications is described. The first wireless device may include a processing system that includes processor circuitry and memory circuitry that stores code. The processing system may be configured to cause the first wireless device to transmit, in accordance with an observed traffic metric between the first wireless device and a second wireless device, a message requesting a reduction in a quantity of operating links associated with a multi-link connection between the first wireless device and the second wireless device, where the message indicates at least one wireless device associated with a reduced quantity of operating links, and where the observed traffic metric indicates an absence of traffic associated with one or more links of the multi-link connection over a time window or an underutilization of the one or more links of the multi-link connection over the time window and communicate with the second wireless device in accordance with the requested reduction in the quantity of operating links.

Another innovative aspect of the subject matter described in this disclosure can be implemented in another first wireless device for wireless communications. The first wireless device may include means for transmitting, in accordance with an observed traffic metric between the first wireless device and a second wireless device, a message requesting a reduction in a quantity of operating links associated with a multi-link connection between the first wireless device and the second wireless device, where the message indicates at least one wireless device associated with a reduced quantity of operating links, and where the observed traffic metric indicates an absence of traffic associated with one or more links of the multi-link connection over a time window or an underutilization of the one or more links of the multi-link connection over the time window and means for communicating with the second wireless device in accordance with the requested reduction in the quantity of operating links.

Another innovative aspect of the subject matter described in this disclosure can be implemented in a non-transitory computer-readable medium storing code for wireless communications is described. The code may include instructions executable by one or more processors to transmit, in accordance with an observed traffic metric between the first wireless device and a second wireless device, a message requesting a reduction in a quantity of operating links associated with a multi-link connection between the first wireless device and the second wireless device, where the message indicates at least one wireless device associated with a reduced quantity of operating links, and where the observed traffic metric indicates an absence of traffic associated with one or more links of the multi-link connection over a time window or an underutilization of the one or more links of the multi-link connection over the time window and communicate with the second wireless device in accordance with the requested reduction in the quantity of operating links.

Some examples of the method, first wireless devices, and non-transitory computer-readable medium described herein may further include operations, features, means, or instructions for receiving a traffic identifier to link mapping (TTLM) request in response to transmitting the message requesting the reduction in the quantity of operating links, where the TTLM request confirms the requested reduction in the quantity of operating links.

Some examples of the method, first wireless devices, and non-transitory computer-readable medium described herein may further include operations, features, means, or instructions for receiving, in accordance with the message, a multi-link reconfiguration request from the second wireless device associated with operating in accordance with the reduction in the quantity of operating links associated with the multi-link connection.

In some examples of the method, first wireless devices, and non-transitory computer-readable medium described herein, transmitting the message may include operations, features, means, or instructions for transmitting the message including a request for the second wireless device to associate or reassociate with the first wireless device using the reduced quantity of operating links associated with the multi-link connection between the first wireless device and the second wireless device.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a hierarchical format of an example PPDU usable for communications between a wireless AP and one or more wireless STAs.

FIG. 3 shows a pictorial diagram of another example wireless communication network.

FIG. 4 shows an example signaling diagram that supports techniques to increase capacity with multi-link operation (MLO).

FIG. 5 shows an example of a process flow that supports techniques to increase capacity with MLO.

FIG. 6 shows a block diagram of an example first wireless device that supports techniques to increase capacity with MLO.

FIG. 7 shows a block diagram of an example second wireless device that supports techniques to increase capacity with MLO.

FIGS. 8-11 show flowcharts illustrating example processes performable by or at a first wireless device that supports techniques to increase capacity with MLO.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, a wireless device (such as an access point (AP)) may communicate with a client device (such as non-AP multi-link device (MLD)) via multiple simultaneous radio links. Supporting multiple radio links for a client device at an AP (such as an AP MLD) may consume more memory than supporting a single link connection for a STA (such as a non-AP MLD). This memory usage may reduce the capacity of the AP to support other client devices and may impact the performance of the wireless device.

Various aspects relate generally to dynamically modifying the number of radio links employed in a connection between a first wireless device (such as an AP) and a second wireless device (such as a STA or a non-AP MLD) according to observed traffic metrics. Some aspects more specifically relate to the first wireless device requesting a reduction in a quantity of operating links between the wireless device and one or more clients. In some implementations, the first wireless device may be connected with the second wireless device via a multi-link connection. The first wireless device may update (such as dynamically reduce or add) one or more links associated with the second wireless device in response to identifying an absence of active data transmission or reception across the one or more links of the multi-link connection. For instance, the first wireless device may identify that the second wireless device has active data transmission or reception on two links or one link while being connected across three links. The first wireless device may identify an underutilization of one or more links of the multi-link connection, for example, by observing a traffic metric associated with the second wireless device over the connection. In accordance with the observed traffic metric, the first wireless device may request a reduction in a quantity of links associated with the multi-link connection.

Particular aspects of the subject matter described in this disclosure can be implemented to realize one or more of the following potential advantages. In some implementations, by reducing the quantity of operating links in response to a detected underutilization of one or more of the operating links, a first wireless device (such as AP MLD) may increase its capacity to service other client devices (such as other non-AP MLDs). By dynamically reducing the quantity of operating links, the first wireless device may free up memory to support additional operating links for more clients, thereby increasing an overall capacity of the first wireless device, enhancing user experience, and supporting greater spectral efficiency.

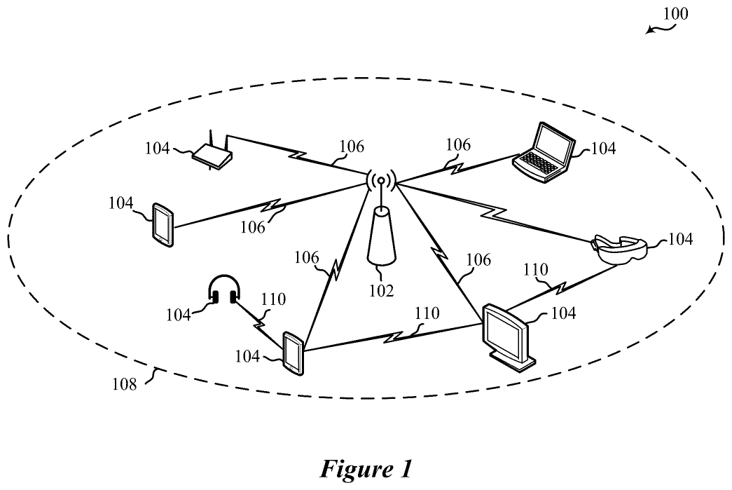

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any quantity of wireless stations (STAs) 104. While one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some implementations, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some implementations, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency thresholds, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput thresholds.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some implementations of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some implementations, the AP 102 or the STAs 104 may be capable of monitoring only a single primary 20 MHz channel for packet detection (such as for detecting preambles of PPDUs). Conventionally, any transmission by an AP 102 or a STA 104 within a BSS involve transmission on the primary 20 MHz channel. As such, in conventional systems, the transmitting device may contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some implementations, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some implementations, the M-Primary channel may be used for beaconing and serving legacy client devices and an O-Primary channel may be specifically used by non-legacy (such as UHR-or IEEE 802.11bn-compatible) devices for opportunistic access to spectrum that may be otherwise under-utilized.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while an UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some implementations in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some implementations, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

Transmitting and receiving devices AP 102 and STA 104 may support the use of various modulation and coding schemes (MCSs) to transmit and receive data in the wireless communication network 100 so as to optimally take advantage of wireless channel conditions, for example, to increase throughput, reduce latency, or enforce various quality of service (QOS) parameters. For example, existing technology (such as IEEE 802.11ax standard amendment protocols) supports the use of up to 1024-QAM, where a modulated symbol carries 10 bits. To further enhance peak data rate, each of the AP 102 or the STA 104 may employ use of 4096-QAM (also referred to as “4k QAM”), which enables a modulated symbol to carry 12 bits. 4k QAM may enable massive peak throughput with a maximum theoretical PHY rate of 10 bps/Hz/subcarrier/spatial stream, which translates to 23 Gbps with 5/6 LDPC code (10 bps/Hz/subcarrier/spatial stream*996*4 subcarriers*8 spatial streams/13.6 μs per OFDM symbol). The AP 102 or the STA 104 using 4096-QAM may enable a 20% increase in data rate compared to 1024-QAM given the same coding rate, thereby allowing users to obtain higher transmission efficiency.

In some implementations, an AP 102 or a STA 104 may support one or more signaling-or configuration-based mechanisms according to which the AP 102 may transmit, in accordance with an observed traffic metric between the AP 102 and the STA 104, a message requesting a reduction in a quantity of operating links associated with a multi-link connection between the AP 102 and the STA 104. In some implementations, the message may indicate at least one wireless device associated with a reduced quantity of operating links. In some aspects, the observed traffic metric may indicate an absence of traffic associated with one or more links of the multi-link connection over a time window or an underutilization of the one or more links of the multi-link connection over the time window.

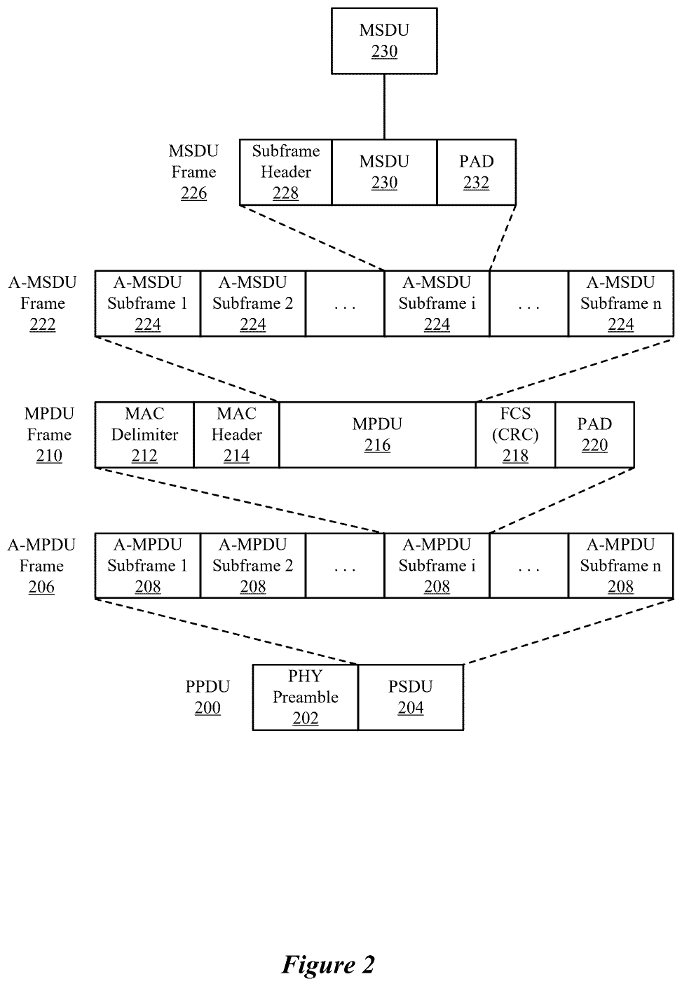

FIG. 2 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 200 includes a PHY preamble 202 and a PSDU 204. Each PSDU 204 may represent (or “carry”) one or more MAC protocol data units (MPDUs) 216. For example, each PSDU 204 may carry an aggregated MPDU (A-MPDU) 206 that includes an aggregation of multiple A-MPDU subframes 208. Each A-MPDU subframe 208 may include an MPDU frame 210 that includes a MAC delimiter 212 and a MAC header 214 prior to the accompanying MPDU 216, which includes the data portion (“payload” or “frame body”) of the MPDU frame 210. Each MPDU frame 210 also may include a frame check sequence (FCS) field 218 for error detection (such as the FCS field 218 may include a cyclic redundancy check (CRC)) and padding bits 220. The MPDU 216 may carry one or more MAC service data units (MSDUs) 230. For example, the MPDU 216 may carry an aggregated MSDU (A-MSDU) 222 including multiple A-MSDU subframes 224. Each A-MSDU subframe 224 may be associated with an MSDU frame 226 and may contain a corresponding MSDU 230 preceded by a subframe header 228 and, in some implementations, followed by padding bits 232.

Referring back to the MPDU frame 210, the MAC delimiter 212 may serve as a marker of the start of the associated MPDU 216 and indicate the length of the associated MPDU 216. The MAC header 214 may include multiple fields containing information that defines or indicates characteristics or attributes of data encapsulated within the frame body. The MAC header 214 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 214 also includes one or more fields indicating addresses for the data encapsulated within the frame body. For example, the MAC header 214 may include a combination of a source address, a transmitter address, a receiver address or a destination address. The MAC header 214 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some implementations, the control frame and fields within the MAC header of the data or management frames, or both, also may be secured either via encryption or via an integrity check (such as by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some implementations, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latencies.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some implementations may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some implementations of such TDMA techniques, each portion of a set of portions of the TXOP includes a set of time resources that do not overlap with any time resources of any other portion of the set of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some implementations of OFDMA techniques, each portion of the set of portions of the TXOP includes a set of frequency resources that do not overlap with any frequency resources of any other portion of the set of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve enhancements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without the sharing AP or the shared APs being aware of the STAs 104 associated with other BSSs, without a preassigned or dedicated master AP or preassigned groups of APs, and without backhaul coordination between the APs participating in the TXOP.

In some implementations in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some implementations, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described herein.

APs and STAs (such as the AP 102 and the STAs 104 described with reference to FIG. 1) that include multiple antennas may support various diversity schemes. For example, spatial diversity may be used by one or both of a transmitting device (such as an AP 102 or a STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to enhance a signal-to-noise ratio (SNR), as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI for beamforming, the beamformer may perform a channel sounding procedure with the beamformee. For example, the beamformer may transmit one or more sounding signals (such as in the form of a null data packet (NDP)) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (such as identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some implementations, multiple APs 102 may simultaneously transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

In some implementations, the AP 102 and STAs 104 can support various multi-user communications; that is, concurrent transmissions from one device to each of multiple devices (such as multiple simultaneous downlink communications from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some implementations, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

In some wireless communications systems, an AP 102 may allocate or assign multiple RUs to a single STA 104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHz and 640 MHz), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment and the 802.11bn standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the EHT-SIG field for an EHT PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some implementations, the RU allocation information in the common field of EHT-SIG can be used to individually allocate RUs to the single user, thereby avoiding the punctured channels. In some other examples, U-SIG may be used to indicate SU preamble puncturing. For example, the SU preamble puncturing may be indicated by a value of the EHT-SIG compression field in U-SIG.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some implementations, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHz, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some implementations, the exchange of information may occur via a beacon frame, a probe request frame, a probe response frame, an association request frame, an association response frame, another management frame, a dedicated action frame, or an operating mode indicator (OMI), among other examples. In some implementations, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some implementations be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some implementations, the parallel communication links may support synchronized transmissions. In some other examples, or during some other durations of time, transmissions over the communication links may be parallel, but not be synchronized or concurrent. Additionally, in some implementations or durations of time, two or more of the communication links may be used for communications between MLDs in the same direction (such as all uplink or all downlink), while in some other examples or durations of time, two or more of the communication links may be used for communications in different directions (such as one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other thresholds for different links. For example, traffic with low latency thresholds may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some implementations, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some implementations, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (such as switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (such as monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in enhancements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may enhance user perceived throughput (UPT) (such as by quickly flushing per-user transmit queues). Similarly, MLO may enhance throughput by enhancing utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

In some environments, locations, or conditions, a regulatory body may impose a power spectral density (PSD) limit for one or more communication channels or for an entire band (such as the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some implementations in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and enhance SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (such as duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

In some implementations, a first wireless device (such as an AP MLD) or a second wireless device (such as a STA or a non-AP MLD) may support one or more signaling-or configuration-based mechanisms according to which the first wireless device may observe a traffic metric over a time window. For instance, the observed traffic metric may indicate an absence of traffic associated with one or more links of a multi-link connection over the time window or an underutilization of the one or more links of the multi-link connection over the time window. The first wireless device may transmit, in accordance with the observed traffic metric between the first wireless device and the second wireless device, a message requesting a reduction in a quantity of operating links associated with the multi-link connection between the first wireless device and the second wireless device. In some implementations, the first wireless device and the second wireless device may communicate in accordance with the reduction of operating links.

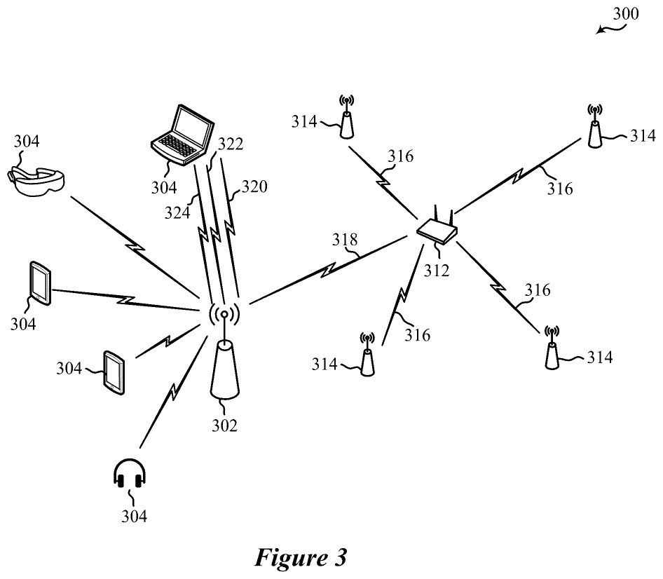

FIG. 3 shows a pictorial diagram of another example wireless communication network 300. According to some aspects, the wireless communication network 300 can be an example of a mesh network, an IoT network, or a sensor network in accordance with one or more of the IEEE 802.11 family of wireless communication protocol standards (including the 802.11ah amendment). The wireless communication network 300 may include multiple wireless devices 314, which in some implementations may include APs 302, STAs 304, or both. The wireless devices 314 may represent various devices such as display devices (such as TVs, computer monitors, navigation systems, among others), music or other audio or stereo devices, remote control devices (“remotes”), printers, kitchen or other household appliances, among other examples.

In some implementations, the wireless devices 314 sense, measure, collect or otherwise obtain and process data and transmit such raw or processed data to an intermediate device 312 for subsequent processing or distribution. Additionally, or alternatively, the intermediate device 312 may transmit control information, digital content (such as audio or video data), configuration information or other instructions to the wireless devices 314. The intermediate device 312 and the wireless devices 314 can communicate with one another via wireless communication links 316. In some implementations, the wireless communication links 316 include Bluetooth links or other PAN or short-range communication links.

In some implementations, the intermediate device 312 also may be configured for wireless communication with other networks such as with a WLAN or a wireless (such as cellular) wide area network (WWAN), which may, in turn, provide access to external networks including the Internet. For example, the intermediate device 312 may associate and communicate, over a Wi-Fi link 318, with an AP 102 of a wireless communication network 300, which also may serve various STAs 104. In some implementations, the intermediate device 312 is an example of a network gateway, for example, an IoT gateway. In such a manner, the intermediate device 312 may serve as an edge network bridge providing a Wi-Fi core backhaul for the IoT network including the wireless devices 314. In some implementations, the intermediate device 312 can analyze, preprocess and aggregate data received from the wireless devices 314 locally at the edge before transmitting it to other devices or external networks via the Wi-Fi link 318. The intermediate device 312 also can provide additional security for the IoT network and the data it transports.

Aspects of transmissions may vary according to a distance between a transmitter (such as an AP 102 or a STA 104) and a receiver (such as another AP 102 or STA 104). Wireless communication devices (such as the AP 102 or the STA 104) may generally benefit from having information regarding the location or proximities of the various STAs 104 within the coverage area. In some implementations, relevant distances may be determined (such as calculated or computed) using RTT-based ranging procedures. Additionally, in some implementations, APs 102 and STAs 104 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

In some implementations, an AP 302 or a STA 304 may support one or more signaling-or configuration-based mechanisms according to which the AP 302 may request a reduction in a quantity of operating links of a multi-link connection between the AP 302 and the STA 304. As depicted in the example of FIG. 3, the AP 302 (such as a first wireless device) may be connected with the STA 304 (such as a second wireless device or a non-AP MLD) using a multi-link connection including three radio links (such as a radio link 320, a radio link 322, and a radio link 324). The AP 302 may observe a traffic metric over a time window. For instance, the observed traffic metric may indicate an absence of traffic associated with one or more links of the multi-link connection over the time window or an underutilization of the one or more links of the multi-link connection over the time window. For instance, the AP 302 may determine that there is an absence of traffic over the radio link 322 and the radio link 324. The AP 302 may transmit, in accordance with the observed traffic metric, a message requesting a reduction in a quantity of operating links associated with the multi-link connection, and may communicate in accordance with the reduction of operating links. For instance, the AP 302 may request the STA 304 to reduce the quantity of operating links from three radio links to a single radio link (such as radio link 320).

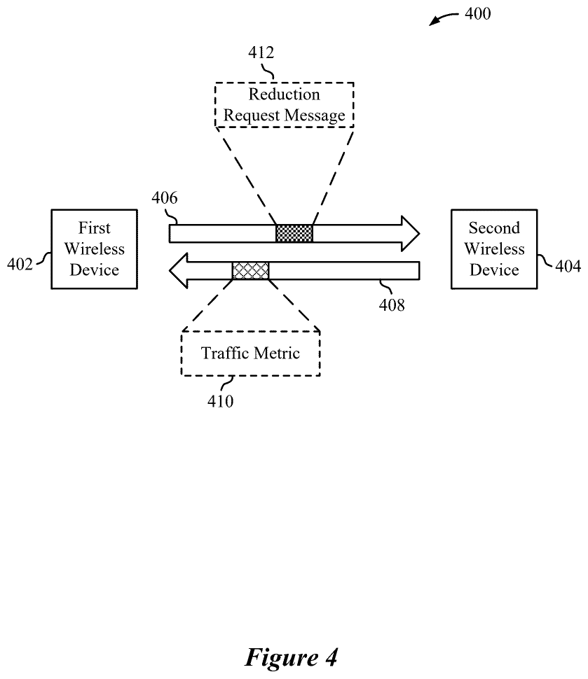

FIG. 4 shows an example of a signaling diagram 400 that supports techniques to increase capacity with MLO. The signaling diagram 400 illustrates communication between a first wireless device 402 and a second wireless device 404 via a communication link 406 and a communication link 408. The first wireless device 402 may be an example of an AP 102, such as an AP 102 as illustrated by and described with reference to FIG. 1 and FIG. 3. The second wireless device 404 may be an example of a STA 104, such as a STA 104 as illustrated by and described with reference to FIG. 1. In some implementations, the first wireless device 402 may be an example of an AP MLD, as described with reference to FIG. 2. The second wireless device 404 may be an example of a non-AP MLD or a STA MLD, as described with reference to FIG. 2. Generally, the first wireless device 402 may be understood or function as a transmitting device and the second wireless device 404 may be understood or function as a receiving device.

In some aspects, an AP (such as the first wireless device 402) may have multiple radios and may support up to a defined quantity of clients on each radio. For example, the first wireless device 402 may support 512 client devices (such as the second wireless device 404) per radio. Additionally, the first wireless device 402 may support multiple connections with one or more wireless devices. In some instances, a connection supporting more than one radio link may consume an increased memory (such as 1.28 times memory footprint). Supporting multiple radio links for a client device at an AP (such as an AP MLD) may consume more memory than supporting a single link connection for the client device. For example, instead of supporting 1536 client devices (such as STAs or non-AP MLDs) using a single operating link, the first wireless device 402 may support 397 clients using three operating links. In addition, to support 512 client devices operating on three radio links, the memory footprint at the first wireless device 402 may increase by 28%. This memory usage may reduce the capacity of the first wireless device 402 to support other client devices and may impact the performance of the first wireless device 402.

In some implementations, the first wireless device 402 may support dynamically modifying the number of radio links employed in a connection between the first wireless device (402 and the second wireless device 404. For instance, the first wireless device 402 may dynamically modify (such as dynamically reduce or add) a quantity of radio links according to observed traffic metrics. Some aspects more specifically relate to the first wireless device 402 requesting a reduction in a quantity of operating links between the first wireless device 402 and the second wireless device 404. To increase the capacity with MLO in wireless communication systems, techniques depicted herein provide for the first wireless device 402 to connect with additional client devices to recover lost capacity (due to establishing multi-link connectivity with multiple client devices) using a current available memory.

For example, the first wireless device 402 may observe current traffic conditions between the first wireless device 402 and one or more clients (such as MLO and SLO clients including the second wireless device 404). If the current traffic conditions indicate that there is an absence of traffic across one or more operating links, or if a client device (such as a STA or non-AP MLD) is currently using less than the assigned quantity of operating links, then the first wireless device 402 may request the client device to reduce a quantity of operating links. Using the techniques depicted herein, the first wireless device 402 support incoming associations while prioritizing maximizing the serviceability. In particular, by reducing a quantity of operating links in response to a detected underutilization of one or more of the operating links, the first wireless device 402 (such as AP MLD) may increase its capacity to service other client devices (such as other non-AP MLDs).

In some implementations, the first wireless device may be connected with the second wireless device via a multi-link connection. The first wireless device 402 may receive, via the communication link 408, a traffic metric 410 (such as observe the traffic metric 410 between the first wireless device 402 and the second wireless device 404) associated with the second wireless device 404. In some implementations, the observed traffic metric 410 may indicate an absence of traffic associated with one or more links of a multi-link connection between the first wireless device 402 and the second wireless device 404 over a time window. For instance, the first wireless device 402 may identify that the second wireless device 404 has active data transmission or reception on two links or one link while being connected across three links. In some aspects, the observed traffic metric 410 may indicate an underutilization of the one or more links of the multi-link connection over the time window. For example, the first wireless device 402 may identify an underutilization of one or more links of the multi-link connection by observing the traffic metric 410 associated with the second wireless device over the connection.

In some instances, the first wireless device 402 may transmit, via the communication link 406, in accordance with an observed traffic metric 410 between the first wireless device 402 and a second wireless device 404, a reconfiguration request message 412. In some instances, the reconfiguration request message 412 may request a reduction in a quantity of operating links associated with a multi-link connection between the first wireless device 402 and the second wireless device 404. The message may indicate at least one wireless device associated with a reduced quantity of operating links. In some aspects, the first wireless device 402 may communicate with the second wireless device 404 in accordance with the requested reduction in the quantity of operating links.

As described herein, a multi-link connection may be associated with limited usage of link-capacity. In this example, the first wireless device 402 may identify one or more clients (such as second wireless device 404) that do not have active data transmission or reception on any MLD across all radios. For instance, the traffic metric 410 may indicate that the second wireless device 404 may be connected to multiple operating links but may not have an active data transmission or reception over the operating links. In such implementations, the first wireless device 402 may request a reduction in a quantity of operating links for the second wireless device 404. Additionally, or alternatively, the first wireless device 402 may identify that the second wireless device 404 may have data transmission or reception scheduled for a quantity of operating links less than a quantity of operating links included in the multi-link connection between the first wireless device 402 and the second wireless device 404. For example, the first wireless device 402 may determine that the second wireless device 404 is connected to three operating links, and that the second wireless device 404 has active data transmission or reception across two of the three operating links or one of the three operating links. In such implementations, the first wireless device 402 may request a reduction in a quantity of operating links for the second wireless device 404. For instance, the first wireless device 402 may request a reduction in operating links from three to two or from three to one.

In some implementations, identifying an absence of traffic, the first wireless device 402 may request that the second wireless device 404 switch to a single link operation. Additionally, or alternatively, identifying an underutilization of one or more links, the first wireless device 402 may request that the second wireless device 404 switch to a two-link operation or a single link operation. In some implementations, the first wireless device 402 may transmit the reconfiguration request message 412 requesting the reduction in the quantity of links (such as for one or more clients) considering that a current throughput of the clients can be maintained using the reduced serving capacity (reduced quantity of links) of those clients. For each MLO peer, the first wireless device may reserve 3280 bytes memory. Thus, reducing the quantity of operating links for one MLO peer may free up memory resulting in 1.28× of memory available for non-MLO clients.

To request reduction in a quantity of operating links, the first wireless device 402 may use a background traffic management (BTM) message or a traffic identifier to link mapping (TTLM) request. It is to be understood that the first wireless device 402 may use additional or alternative techniques to request reduction in a quantity of operating links. In some implementations, the first wireless device 402 may use the BTM protocol to recommend the second wireless device 404 (such as non-AP MLD) to perform an association or a reassociation with the first wireless device 402 (such as same AP MLD) with a different set of operating links. The second wireless device 404 may follow the recommendation by associating or reassociated with the first wireless device 402 using the recommended set of links. For example, the first wireless device 402 may transmit the reconfiguration request message 412 including a request for the second wireless device 404 to associate or reassociate with the first wireless device 402 using the reduced quantity of operating links associated with the multi-link connection between the first wireless device 402 and the second wireless device 404. In some implementations, the second wireless device 404 may include a non-service level agreement (SLA) client.

Additionally, or alternatively, the second wireless device 404 may initiate a multi-link reconfiguration negotiation to operate with the recommended set of links (such as reduced quantity of operating links). For instance, the first wireless device 402 may receive, in accordance with the reconfiguration request message 412, a multi-link reconfiguration request from the second wireless device 404 associated with operating in accordance with the reduction in the quantity of operating links associated with the multi-link connection between the first wireless device 402 and the second wireless device 404. In some implementations, the multi-link reconfiguration request may indicate that at least one operating link excluded from the reduced quantity of operating links is dropped.

In some implementations, the second wireless device 404 may initiate a TTLM negotiation if one or more of the enabled links matches the set of recommended links. For example, the first wireless device 402 may receive a TTLM request in response to transmitting the reconfiguration request message 412 requesting the reduction in the quantity of operating links. In some implementations, the TTLM request may confirm the requested reduction in the quantity of operating links. In some implementations, the TTLM request may indicate a mapping between one or more traffic identifiers and the reduced quantity of operating links. In such implementations, the first wireless device 402 may transmit a link reconfiguration notification request to delete one or more operating links.

In some aspects, the first wireless device 402 may request an increase to a previously reduced quantity of operating links. For instance, the first wireless device 402 may observe an increase in traffic associated with one or more links over a time period. In such implementations, the first wireless device 402 may transmit a second message requesting an increase to the reduced quantity of operating links associated with the multi-link connection between the first wireless device 402 and the second wireless device 404. Thus, the first wireless device 402 (such as AP MLD) and the second wireless device 404 (such as non-AP MLD) may use MLO associated with the traffic. For instance, the first wireless device 402 and the second wireless device 404 may use MLO if the first wireless device 402 determines that multiple operating links are being used for data operation or if an application at the second wireless device 404 requests MLO connectivity (such as AR/VR).

In some implementations, in accordance with reducing the quantity of operating links, the first wireless device 402 may use the additional available memory to allow new clients (such as SLO clients) to connect to the first wireless device 402, thereby increasing network capacity. Additionally, or alternatively, the first wireless device 402 may allow additional service instances (such as service instances for service defined Wi-Fi (SDWF)) to run on the first wireless device 402, which may help to prioritize traffic for more clients or add additional service instances for clients. In some implementations, the first wireless device 402 may assign additional services for clients which have active traffic running with reduced quantity of operating links.

In some implementations, in accordance with determining that the first wireless device 402 is reaching capacity in terms of serviceability (such as maximum client connectivity), the first wireless device 402 may initiate observing the traffic metric 410. Thus, at near capacity (such as in terms of memory footprint), the first wireless device 402 may prioritize serviceability over quality of service (QOS), in some instances. In some aspects, the first wireless device 402 may determine the reduced quantity of operating links for a client associated with an effective link capacity associated with the client. To effectively balance QoS across multiple clients, the first wireless device 402 may mark or otherwise track the clients with reduced operating links for serviceability. In some implementations, the first wireless device 402 may store such client information such that the same client is not impacted during load-balancing. Additionally, using the techniques depicted herein, a customer may request a quantity of clients to be serviced using 1 or 2 link connections via configurable knobs. In some aspects, such request may be in accordance with a type of client or may be in accordance with device identification or SLA associated with each client.

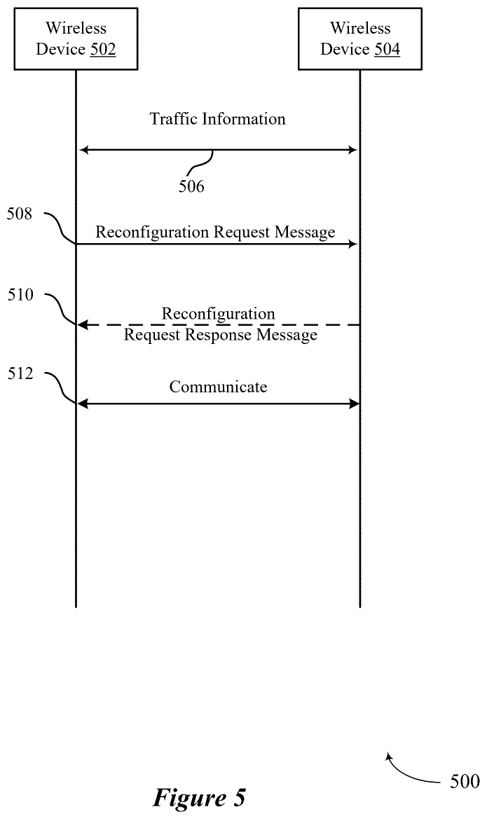

FIG. 5 shows an example of a process flow 500 that supports techniques to increase capacity with MLO. The process flow 500 may implement or be implemented by aspects of the wireless communication network 100, the PPDU 200, the wireless communication network 300 or a signaling diagram 400, as shown and described with reference to FIGS. 1-4. For example, the process flow 500 includes the wireless device 502, which may be an example of an AP 102 (such as AP MLD), such as an AP 102 as illustrated by and described with reference to FIG. 1, and the wireless device 504 may be an example of a STA 104 (such as a client device or a non-AP MLD), such as a STA 104 as illustrated by and described with reference to FIG. 1. In the following description of the process flow 500, operations between the wireless device 502 and the wireless device 504 may be added, omitted, or performed in a different order (with respect to the example order shown in FIG. 5).

At 506, the wireless device 502 (such as an AP MLD) may receive traffic information from the wireless device 504 (such as a non-AP MLD). In some implementations, the wireless device 502 may observe a traffic metric associated with the received traffic information. The observed traffic metric may indicate an absence of traffic associated with one or more links of a multi-link connection over a time window or an underutilization of the one or more links of the multi-link connection over the time window.

At 508, the wireless device 502 may transmit, in accordance with the observed traffic metric between the wireless device 502 and the wireless device 504, a reconfiguration request for reduction in a quantity of operating links associated with a multi-link connection between the wireless device 502 and the wireless device 504. In some implementations, the request may indicate at least one wireless device associated with a reduced quantity of operating links. The wireless device 502 may transmit the request as, for example, a BTM message, a TTLM message, or a message defined according to another applicable protocol.

At 510, the wireless device 502 may receive a response message to the reconfiguration request message transmitted at 508. In some implementations, the wireless device 502 may receive a TTLM request in response to transmitting the request for reduction in the quantity of operating links. The TTLM request may confirm the requested reduction in the quantity of operating links. Additionally, or alternatively, the TTLM request may indicate a mapping between one or more traffic identifiers and the reduced quantity of operating links.

In some aspects, the wireless device 502 may receive a multi-link reconfiguration request from the wireless device 504 associated with operating in accordance with the reduction in the quantity of operating links associated with the multi-link connection. The multi-link reconfiguration request may indicate that at least one operating link excluded from the reduced quantity of operating links is dropped.

At 512, the wireless device 502 and the wireless device 504 may communicate in accordance with the requested reduction in the quantity of operating links. In some implementations, the wireless device 502 may perform data exchange with the wireless device 504 using a reduced quantity of operating links (such as reduced from three operating links to two operating links or reduced from three operating links to a single operating link). For instance, the wireless device 504 may transmit data to the wireless device 502 or receive data from the wireless device 502 using the reduced quantity of operating links.

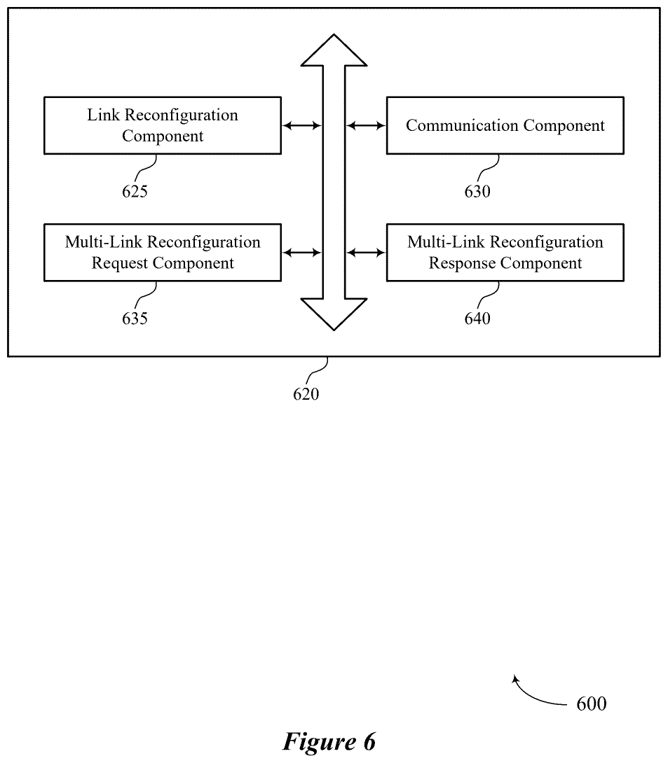

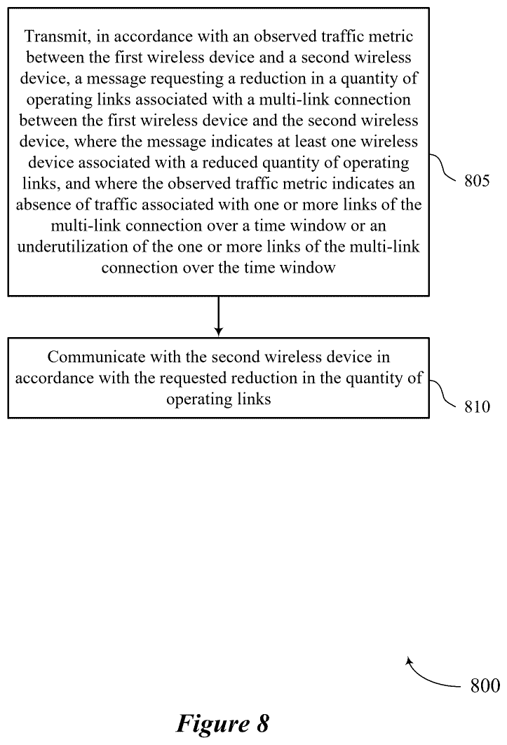

FIG. 6 shows a block diagram of an example first wireless device 600 that supports techniques to increase capacity with MLO. In some implementations, the first wireless device 600 is configured to perform the processes 800, 900, and 1000 described with reference to FIGS. 8, 9, and 10, respectively. The first wireless device 600 may include one or more chips, SoCs, chipsets, packages, components or devices that individually or collectively constitute or include a processing system. The processing system may interface with other components of the first wireless device 600, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the first wireless device 600 may transmit the information output from the chip. In such an example, the second interface may refer to an interface between the processing system of the chip and a reception component, such that the first wireless device 600 may receive information that is passed to the processing system. In some such examples, the first interface also may obtain information, such as from the transmission component, and the second interface also may output information, such as to the reception component.

The processing system of the first wireless device 600 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some implementations, one or more of the processors may be preconfigured to perform various functions or operations described herein without configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, the first wireless device 600 can be configurable or configured for use in an AP, such as the AP 102 described with reference to FIG. 1. In some other examples, the first wireless device 600 can be an AP that includes such a processing system and other components including multiple antennas. The first wireless device 600 is capable of transmitting and receiving wireless communications in the form of, for example, wireless packets. For example, the first wireless device 600 can be configurable or configured to transmit and receive packets in the form of physical layer PPDUs and MPDUs conforming to one or more of the IEEE 802.11 family of wireless communication protocol standards. In some other examples, the first wireless device 600 can be configurable or configured to transmit and receive signals and communications conforming to one or more 3GPP specifications including those for 5G NR or 6G. In some implementations, the first wireless device 600 also includes or can be coupled with one or more application processors which may be further coupled with one or more other memories. In some implementations, the first wireless device 600 further includes at least one external network interface coupled with the processing system that enables communication with a core network or backhaul network that enables the first wireless device 600 to gain access to external networks including the Internet.

The first wireless device 600 includes a link reconfiguration component 625, a communication component 630, a multi-link reconfiguration request component 635, and a multi-link reconfiguration response component 640. Portions of one or more of the link reconfiguration component 625, the communication component 630, the multi-link reconfiguration request component 635, and the multi-link reconfiguration response component 640 may be implemented at least in part in hardware or firmware. For example, one or more of the link reconfiguration component 625, the communication component 630, the multi-link reconfiguration request component 635, and the multi-link reconfiguration response component 640 may be implemented at least in part by at least a processor or a modem. In some implementations, portions of one or more of the link reconfiguration component 625, the communication component 630, the multi-link reconfiguration request component 635, and the multi-link reconfiguration response component 640 may be implemented at least in part by a processor and software in the form of processor-executable code stored in memory.

The first wireless device 600 may support wireless communications in accordance with examples as disclosed herein. The link reconfiguration component 625 is configurable or configured to transmit, in accordance with an observed traffic metric between the first wireless device and a second wireless device, a message requesting a reduction in a quantity of operating links associated with a multi-link connection between the first wireless device and the second wireless device, where the message indicates at least one wireless device associated with a reduced quantity of operating links, and where the observed traffic metric indicates an absence of traffic associated with one or more links of the multi-link connection over a time window or an underutilization of the one or more links of the multi-link connection over the time window. The communication component 630 is configurable or configured to communicate with the second wireless device in accordance with the requested reduction in the quantity of operating links. In some implementations, the first wireless device includes an AP and the second wireless device includes a non-AP MLD.

In some implementations, the link reconfiguration component 625 is configurable or configured to transmit, in accordance with the observed traffic metric between the first wireless device and the second wireless device, a second message requesting an increase in the quantity of operating links associated with the multi-link connection between the first wireless device and the second wireless device.

In some implementations, the multi-link reconfiguration request component 635 is configurable or configured to receive a TTLM request in response to transmitting the message requesting the reduction in the quantity of operating links, where the TTLM request confirms the requested reduction in the quantity of operating links. In some implementations, the TTLM request indicates a mapping between one or more traffic identifiers and the reduced quantity of operating links. In some implementations, the multi-link reconfiguration response component 640 is configurable or configured to transmit a response to the TTLM request received in response to the message requesting the reduction in the quantity of operating links.

In some implementations, the multi-link reconfiguration request component 635 is configurable or configured to receive, in accordance with the message, a multi-link reconfiguration request from the second wireless device associated with operating in accordance with the reduction in the quantity of operating links associated with the multi-link connection. In some implementations, the multi-link reconfiguration request indicates that at least one operating link excluded from the reduced quantity of operating links is dropped. In some implementations, the multi-link reconfiguration response component 640 is configurable or configured to transmit a response to the multi-link reconfiguration request received from the second wireless device.

In some implementations, to support transmitting the message, the link reconfiguration component 625 is configurable or configured to transmit the message including a request for the second wireless device to associate or reassociate with the first wireless device using the reduced quantity of operating links associated with the multi-link connection between the first wireless device and the second wireless device.

In some implementations, the link reconfiguration component 625 is configurable or configured to transmit, in accordance with the observed traffic metric, a second message requesting an increase to the reduced quantity of operating links associated with the multi-link connection between the first wireless device and the second wireless device, where the observed traffic metric indicates an increase in traffic associated with the one or more links of the multi-link connection over a second time window. In some implementations, the message includes a BTM message or a TTLM request.

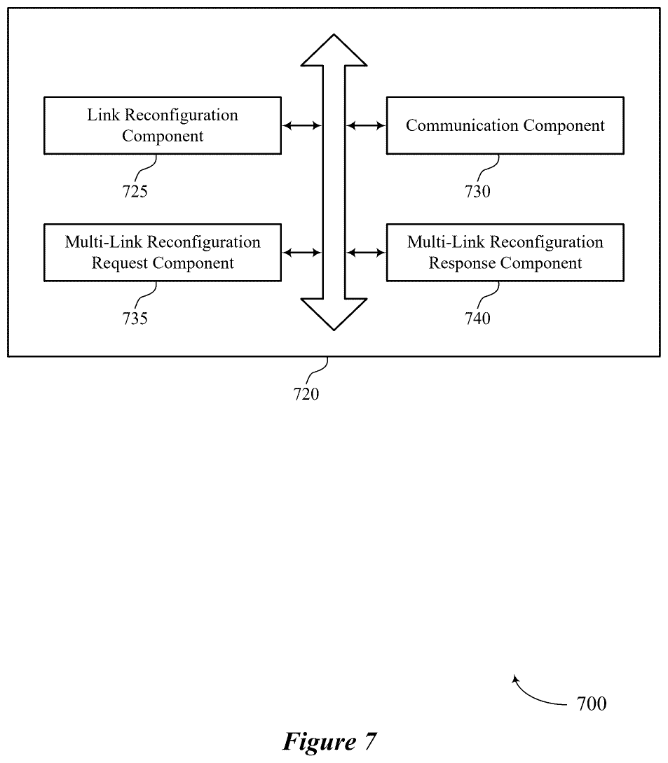

FIG. 7 shows a block diagram of an example second wireless device 700 that supports techniques to increase capacity with MLO. In some implementations, the second wireless device 700 in combination with the first wireless device 600 is configured to perform the processes 800, 900, and 1000 described with reference to FIGS. 8, 9, and 10, respectively. The second wireless device 700 may include one or more chips, SoCs, chipsets, packages, components or devices that individually or collectively constitute or include a processing system. The processing system may interface with other components of the second wireless device 700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the second wireless device 700 may transmit the information output from the chip. In such an example, the second interface may refer to an interface between the processing system of the chip and a reception component, such that the second wireless device 700 may receive information that is passed to the processing system. In some such examples, the first interface also may obtain information, such as from the transmission component, and the second interface also may output information, such as to the reception component.

The processing system of the second wireless device 700 includes processor (or “processing”) circuitry in the form of one or multiple processors, microprocessors, processing units (such as CPUs, GPUs, NPUs (also referred to as neural network processors or DLPs), or DSPs), processing blocks, ASIC, PLDs (such as FPGAs), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as RAM or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some implementations, one or more of the processors may be preconfigured to perform various functions or operations described herein without configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, the second wireless device 700 can be configurable or configured for use in a STA, such as the STA 104 described with reference to FIG. 1. In some other examples, the second wireless device 700 can be a STA that includes such a processing system and other components including multiple antennas. The second wireless device 700 is capable of transmitting and receiving wireless communications in the form of, for example, wireless packets. For example, the second wireless device 700 can be configurable or configured to transmit and receive packets in the form of physical layer PPDUs and MPDUs conforming to one or more of the IEEE 802.11 family of wireless communication protocol standards. In some other examples, the second wireless device 700 can be configurable or configured to transmit and receive signals and communications conforming to one or more 3GPP specifications including those for 5G NR or 6G. In some implementations, the second wireless device 700 also includes or can be coupled with one or more application processors which may be further coupled with one or more other memories. In some implementations, the second wireless device 700 further includes at least one external network interface coupled with the processing system that enables communication with a core network or backhaul network that enables the second wireless device 700 to gain access to external networks including the Internet.

The second wireless device 700 includes a link reconfiguration component 725, a communication component 730, a multi-link reconfiguration request component 735, and a multi-link reconfiguration response component 740. Portions of one or more of the link reconfiguration component 725, the communication component 730, the multi-link reconfiguration request component 735, and the multi-link reconfiguration response component 740 may be implemented at least in part in hardware or firmware. For example, one or more of the link reconfiguration component 725, the communication component 730, the multi-link reconfiguration request component 735, and the multi-link reconfiguration response component 740 may be implemented at least in part by at least a processor or a modem. In some implementations, portions of one or more of the link reconfiguration component 725, the communication component 730, the multi-link reconfiguration request component 735, and the multi-link reconfiguration response component 740 may be implemented at least in part by a processor and software in the form of processor-executable code stored in memory.

The second wireless device 700 may support wireless communications in accordance with examples as disclosed herein. The link reconfiguration component 725 is configurable or configured to receive, in accordance with an observed traffic metric between a first wireless device and the second wireless device, a message requesting a reduction in a quantity of operating links associated with a multi-link connection between the first wireless device and the second wireless device, where the message indicates at least one wireless device associated with a reduced quantity of operating links, and where the observed traffic metric indicates an absence of traffic associated with one or more links of the multi-link connection over a time window or an underutilization of the one or more links of the multi-link connection over the time window. The communication component 730 is configurable or configured to communicate with the first wireless device in accordance with the requested reduction in the quantity of operating links.

In some implementations, the link reconfiguration component 725 is configurable or configured to receive, in accordance with the observed traffic metric between the first wireless device and the second wireless device, a second message requesting an increase in the quantity of operating links associated with the multi-link connection between the first wireless device and the second wireless device.

In some implementations, the multi-link reconfiguration request component 735 is configurable or configured to transmit a TTLM request in response to receiving the message requesting the reduction in the quantity of operating links, where the TTLM request confirms the requested reduction in the quantity of operating links. In some implementations, the TTLM request indicates a mapping between one or more traffic identifiers and the reduced quantity of operating links. In some implementations, the multi-link reconfiguration response component 740 is configurable or configured to receive a response to the TTLM request received in response to the message requesting the reduction in the quantity of operating links.

In some implementations, the multi-link reconfiguration request component 735 is configurable or configured to transmit, in accordance with the message, a multi-link reconfiguration request from the second wireless device associated with operating in accordance with the reduction in the quantity of operating links associated with the multi-link connection. In some implementations, the multi-link reconfiguration request indicates that at least one operating link excluded from the reduced quantity of operating links is dropped. In some implementations, the multi-link reconfiguration response component 740 is configurable or configured to receive a response to the multi-link reconfiguration request transmitted to the first wireless device.

In some implementations, to support transmitting the message, the link reconfiguration component 725 is configurable or configured to receive the message including a request for the second wireless device to associate or reassociate with the first wireless device using the reduced quantity of operating links associated with the multi-link connection between the first wireless device and the second wireless device.

In some implementations, the link reconfiguration component 725 is configurable or configured to receive, in accordance with the observed traffic metric, a second message requesting an increase to the reduced quantity of operating links associated with the multi-link connection between the first wireless device and the second wireless device, where the observed traffic metric indicates an increase in traffic associated with the one or more links of the multi-link connection over a second time window. In some implementations, the message includes a BTM message or a TTLM request.

FIG. 8 shows a flowchart illustrating an example process 800 performable by or at a first wireless device that supports techniques to increase capacity with MLO. The operations of the process 800 may be implemented by a first wireless device or its components as described herein. For example, the process 800 may be performed by a first wireless device, such as the first wireless device 600 described with reference to FIG. 6, operating as or within a wireless AP. In some implementations, the process 800 may be performed by a wireless AP, such as one of the APs 102 described with reference to FIG. 1.

In some implementations, in 805, the first wireless device may transmit, in accordance with an observed traffic metric between the first wireless device and a second wireless device, a message requesting a reduction in a quantity of operating links associated with a multi-link connection between the first wireless device and the second wireless device, where the message indicates at least one wireless device associated with a reduced quantity of operating links, and where the observed traffic metric indicates an absence of traffic associated with one or more links of the multi-link connection over a time window or an underutilization of the one or more links of the multi-link connection over the time window. The operations of 805 may be performed in accordance with examples as disclosed herein. In some implementations, aspects of the operations of 805 may be performed by a link reconfiguration component 625 as described with reference to FIG. 6.

In some implementations, in 810, the first wireless device may communicate with the second wireless device in accordance with the requested reduction in the quantity of operating links. The operations of 810 may be performed in accordance with examples as disclosed herein. In some implementations, aspects of the operations of 810 may be performed by a communication component 630 as described with reference to FIG. 6.

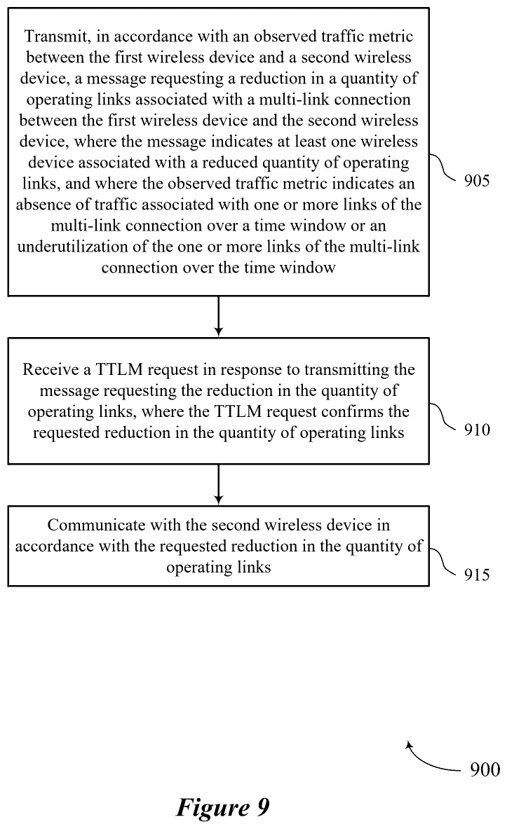

FIG. 9 shows a flowchart illustrating an example process 900 performable by or at a first wireless device that supports techniques to increase capacity with MLO. The operations of the process 900 may be implemented by a first wireless device or its components as described herein. For example, the process 900 may be performed by a first wireless device, such as the first wireless device 600 described with reference to FIG. 6, operating as or within a wireless AP. In some implementations, the process 900 may be performed by a wireless AP, such as one of the APs 102 described with reference to FIG. 1.

In some implementations, in 905, the first wireless device may transmit, in accordance with an observed traffic metric between the first wireless device and a second wireless device, a message requesting a reduction in a quantity of operating links associated with a multi-link connection between the first wireless device and the second wireless device, where the message indicates at least one wireless device associated with a reduced quantity of operating links, and where the observed traffic metric indicates an absence of traffic associated with one or more links of the multi-link connection over a time window or an underutilization of the one or more links of the multi-link connection over the time window. The operations of 905 may be performed in accordance with examples as disclosed herein. In some implementations, aspects of the operations of 905 may be performed by a link reconfiguration component 625 as described with reference to FIG. 6.

In some implementations, in 910, the first wireless device may receive a TTLM request in response to transmitting the message requesting the reduction in the quantity of operating links, where the TTLM request confirms the requested reduction in the quantity of operating links. The operations of 910 may be performed in accordance with examples as disclosed herein. In some implementations, aspects of the operations of 910 may be performed by a multi-link reconfiguration request component 635 as described with reference to FIG. 6.

In some implementations, in 915, the first wireless device may communicate with the second wireless device in accordance with the requested reduction in the quantity of operating links. The operations of 915 may be performed in accordance with examples as disclosed herein. In some implementations, aspects of the operations of 915 may be performed by a communication component 630 as described with reference to FIG. 6.

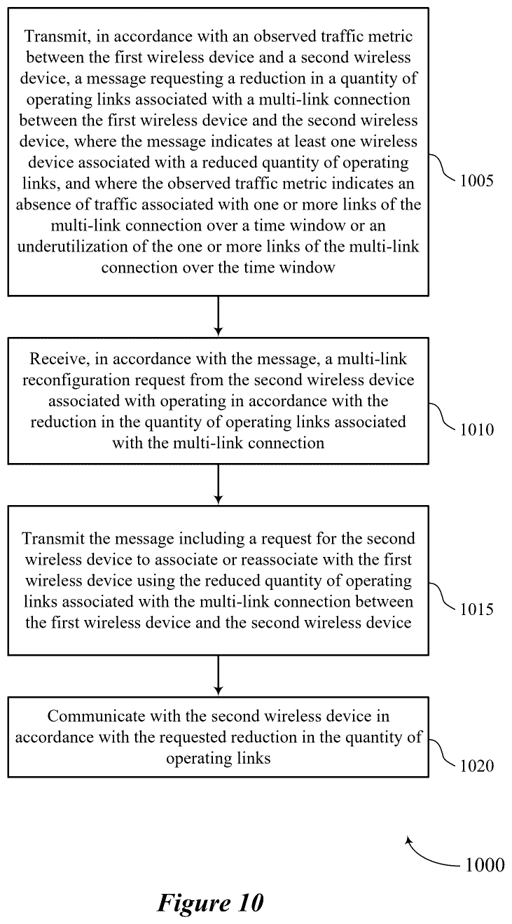

FIG. 10 shows a flowchart illustrating an example process 1000 performable by or at a first wireless device that supports techniques to increase capacity with MLO. The operations of the process 1000 may be implemented by a first wireless device or its components as described herein. For example, the process 1000 may be performed by a first wireless device, such as the first wireless device 600 described with reference to FIG. 6, operating as or within a wireless AP. In some implementations, the process 1000 may be performed by a wireless AP, such as one of the APs 102 described with reference to FIG. 1.

In some implementations, in 1005, the first wireless device may transmit, in accordance with an observed traffic metric between the first wireless device and a second wireless device, a message requesting a reduction in a quantity of operating links associated with a multi-link connection between the first wireless device and the second wireless device, where the message indicates at least one wireless device associated with a reduced quantity of operating links, and where the observed traffic metric indicates an absence of traffic associated with one or more links of the multi-link connection over a time window or an underutilization of the one or more links of the multi-link connection over the time window. The operations of 1005 may be performed in accordance with examples as disclosed herein. In some implementations, aspects of the operations of 1005 may be performed by a link reconfiguration component 625 as described with reference to FIG. 6.

In some implementations, in 1010, the first wireless device may receive, in accordance with the message, a multi-link reconfiguration request from the second wireless device associated with operating in accordance with the reduction in the quantity of operating links associated with the multi-link connection. The operations of 1010 may be performed in accordance with examples as disclosed herein. In some implementations, aspects of the operations of 1010 may be performed by a multi-link reconfiguration request component 635 as described with reference to FIG. 6.

In some implementations, in 1015, the first wireless device may transmit the message including a request for the second wireless device to associate or reassociate with the first wireless device using the reduced quantity of operating links associated with the multi-link connection between the first wireless device and the second wireless device. The operations of 1015 may be performed in accordance with examples as disclosed herein. In some implementations, aspects of the operations of 1015 may be performed by a link reconfiguration component 625 as described with reference to FIG. 6.

In some implementations, in 1020, the first wireless device may communicate with the second wireless device in accordance with the requested reduction in the quantity of operating links. The operations of 1020 may be performed in accordance with examples as disclosed herein. In some implementations, aspects of the operations of 1020 may be performed by a communication component 630 as described with reference to FIG. 6.

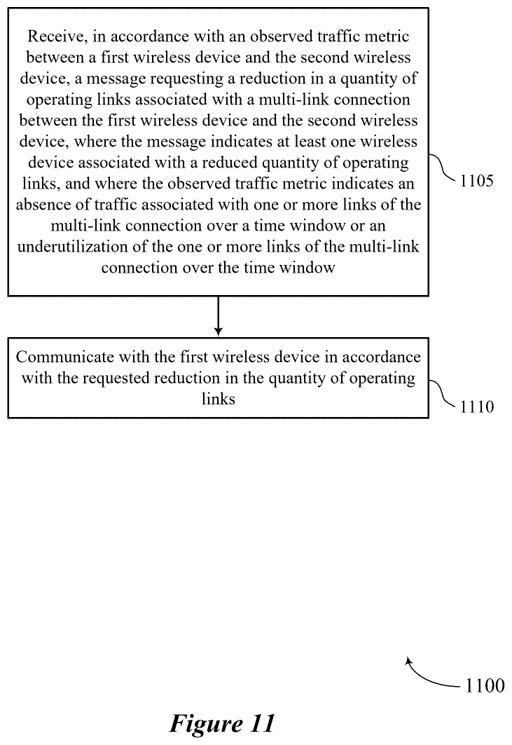

FIG. 11 shows a flowchart illustrating an example process 1100 performable by or at a second wireless device that supports techniques to increase capacity with MLO. The operations of the process 1100 may be implemented by a second wireless device or its components as described herein. For example, the process 1100 may be performed by a second wireless device, such as the second wireless device 700 described with reference to FIG. 7, operating as or within a wireless STA. In some implementations, the process 1100 may be performed by a wireless STA, such as one of the STAs 104 described with reference to FIG. 1.

In some implementations, in 1105, the second wireless device may receive, in accordance with an observed traffic metric between a first wireless device and the second wireless device, a message requesting a reduction in a quantity of operating links associated with a multi-link connection between the first wireless device and the second wireless device, where the message indicates at least one wireless device associated with a reduced quantity of operating links, and where the observed traffic metric indicates an absence of traffic associated with one or more links of the multi-link connection over a time window or an underutilization of the one or more links of the multi-link connection over the time window. The operations of 1105 may be performed in accordance with examples as disclosed herein. In some implementations, aspects of the operations of 1105 may be performed by a link reconfiguration component 725 as described with reference to FIG. 7.

In some implementations, in 1110, the second wireless device may communicate with the first wireless device in accordance with the requested reduction in the quantity of operating links. The operations of 1110 may be performed in accordance with examples as disclosed herein. In some implementations, aspects of the operations of 1110 may be performed by a communication component 730 as described with reference to FIG. 7.

Implementation examples are described in the following numbered clauses:

The following provides an overview of aspects of the present disclosure:

Aspect 1: A method for wireless communications at a first wireless device, comprising: transmitting, in accordance with an observed traffic metric between the first wireless device and a second wireless device, a message requesting a reduction in a quantity of operating links associated with a multi-link connection between the first wireless device and the second wireless device, wherein the message indicates at least one wireless device associated with a reduced quantity of operating links, and wherein the observed traffic metric indicates an absence of traffic associated with one or more links of the multi-link connection over a time window or an underutilization of the one or more links of the multi-link connection over the time window; and communicating with the second wireless device in accordance with the requested reduction in the quantity of operating links.

Aspect 2: The method of aspect 1, further comprising: receiving a traffic identifier to link mapping (TTLM) request in response to transmitting the message requesting the reduction in the quantity of operating links, wherein the TTLM request confirms the requested reduction in the quantity of operating links.

Aspect 3: The method of aspect 2, wherein the TTLM request indicates a mapping between one or more traffic identifiers and the reduced quantity of operating links.

Aspect 4: The method of any of aspects 1 through 3, further comprising: receiving, in accordance with the message, a multi-link reconfiguration request from the second wireless device associated with operating in accordance with the reduction in the quantity of operating links associated with the multi-link connection.

Aspect 5: The method of aspect 4, wherein the multi-link reconfiguration request indicates that at least one operating link excluded from the reduced quantity of operating links is dropped.

Aspect 6: The method of any of aspects 1 through 5, wherein transmitting the message further comprises: transmitting the message comprising a request for the second wireless device to associate or reassociate with the first wireless device using the reduced quantity of operating links associated with the multi-link connection between the first wireless device and the second wireless device.

Aspect 7: The method of any of aspects 1 through 6, further comprising: transmitting, in accordance with the observed traffic metric, a second message requesting an increase to the reduced quantity of operating links associated with the multi-link connection between the first wireless device and the second wireless device, wherein the observed traffic metric indicates an increase in traffic associated with the one or more links of the multi-link connection over a second time window.

Aspect 8: The method of any of aspects 1 through 7, wherein the message comprises a basic service set (BTM) message or a traffic identifier to link mapping (TTLM) request.

Aspect 9: A first wireless device for wireless communications, comprising one or more memories storing processor-executable code, and one or more processors coupled with the one or more memories and individually or collectively operable to execute the code to cause the first wireless device to perform a method of any of aspects 1 through 8.

Aspect 10: A first wireless device for wireless communications, comprising at least one means for performing a method of any of aspects 1 through 8.

Aspect 11: A non-transitory computer-readable medium storing code for wireless communications, the code comprising instructions executable by one or more processors to perform a method of any of aspects 1 through 8.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described herein as acting in particular combinations, and even initially claimed as such, one or more features from a claimed combination can in some implementations be excised from the combination, and the claimed combination may be directed to a subcombination or variation of a subcombination.

Similarly, while operations are depicted in the drawings in a particular order, this may not be understood as that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described herein may not be understood as such separation in all examples, and it may be understood that the described program components and systems can generally be integrated together in a single software product or packaged into multiple software products.

What is claimed is:

1. A first wireless device, comprising:
a processing system that includes processor circuitry and memory circuitry that stores code, the processing system configured to cause the first wireless device to:
transmit, in accordance with an observed traffic metric between the first wireless device and a second wireless device, a message requesting a reduction in a quantity of operating links associated with a multi-link connection between the first wireless device and the second wireless device,
wherein the message indicates at least one wireless device associated with a reduced quantity of operating links, and wherein the observed traffic metric indicates an absence of traffic associated with one or more links of the multi-link connection over a time window or an underutilization of the one or more links of the multi-link connection over the time window; and
communicate with the second wireless device in accordance with the requested reduction in the quantity of operating links.

2. The first wireless device of claim 1, wherein the processing system is further configured to cause the first wireless device to:
receive a traffic identifier to link mapping (TTLM) request in response to transmitting the message requesting the reduction in the quantity of operating links, wherein the TTLM request confirms the requested reduction in the quantity of operating links.

3. The first wireless device of claim 2, wherein the TTLM request indicates a mapping between one or more traffic identifiers and the reduced quantity of operating links.

4. The first wireless device of claim 1, wherein the processing system is further configured to cause the first wireless device to:
receive, in accordance with the message, a multi-link reconfiguration request from the second wireless device associated with operating in accordance with the reduction in the quantity of operating links associated with the multi-link connection.

5. The first wireless device of claim 4, wherein the multi-link reconfiguration request indicates that at least one operating link excluded from the reduced quantity of operating links is dropped.

6. The first wireless device of claim 1, wherein, to transmit the message, the processing system is further configured to cause the first wireless device to:
transmit the message comprising a request for the second wireless device to associate or reassociate with the first wireless device using the reduced quantity of operating links associated with the multi-link connection between the first wireless device and the second wireless device.

7. The first wireless device of claim 1, wherein the processing system is further configured to cause the first wireless device to:
transmit, in accordance with the observed traffic metric, a second message requesting an increase to the reduced quantity of operating links associated with the multi-link connection between the first wireless device and the second wireless device.

8. The first wireless device of claim 7, wherein the observed traffic metric indicates an increase in traffic associated with the one or more links of the multi-link connection over a second time window.

9. The first wireless device of claim 1, wherein the message comprises a background traffic management (BTM) message or a traffic identifier to link mapping (TTLM) request.

10. The first wireless device of claim 1, wherein the first wireless device includes an access point (AP) and the second wireless device includes a non-AP multi-link device (MLD).

11. A method for wireless communications at a first wireless device, comprising:
transmitting, in accordance with an observed traffic metric between the first wireless device and a second wireless device, a message requesting a reduction in a quantity of operating links associated with a multi-link connection between the first wireless device and the second wireless device, wherein the message indicates at least one wireless device associated with a reduced quantity of operating links, and wherein the observed traffic metric indicates an absence of traffic associated with one or more links of the multi-link connection over a time window or an underutilization of the one or more links of the multi-link connection over the time window; and
communicating with the second wireless device in accordance with the requested reduction in the quantity of operating links.

12. The method of claim 11, further comprising:
receiving a traffic identifier to link mapping (TTLM) request in response to transmitting the message requesting the reduction in the quantity of operating links, wherein the TTLM request confirms the requested reduction in the quantity of operating links.

13. The method of claim 12, wherein the TTLM request indicates a mapping between one or more traffic identifiers and the reduced quantity of operating links.

14. The method of claim 11, further comprising:
receiving, in accordance with the message, a multi-link reconfiguration request from the second wireless device associated with operating in accordance with the reduction in the quantity of operating links associated with the multi-link connection.

15. The method of claim 14, wherein the multi-link reconfiguration request indicates that at least one operating link excluded from the reduced quantity of operating links is dropped.

16. The method of claim 11, wherein transmitting the message further comprises:
transmitting the message comprising a request for the second wireless device to associate or reassociate with the first wireless device using the reduced quantity of operating links associated with the multi-link connection between the first wireless device and the second wireless device.

17. The method of claim 11, further comprising:
transmitting, in accordance with the observed traffic metric, a second message requesting an increase to the reduced quantity of operating links associated with the multi-link connection between the first wireless device and the second wireless device.

18. The method of claim 17, wherein the observed traffic metric indicates an increase in traffic associated with the one or more links of the multi-link connection over a second time window.

19. The method of claim 11, wherein the message comprises a background traffic management (BTM) message or a traffic identifier to link mapping (TTLM) request.

20. The method of claim 11, wherein the first wireless device includes an access point (AP) and the second wireless device includes a non-AP multi-link device (MLD).
